(19) United States
(12) Patent Application Publication
(10) Pub. No.: US 2026/0030897 A1
(43) Pub. Date: Jan. 29, 2026

(54) Method and Apparatus for Analysing an External Vehicle Status

(71) Applicant: Bayerische Motoren Werke Aktiengesellschaft, Muenchen (DE)

(72) Inventors: Florian Schlather, Marzling (DE); Christian Patron, Muenchen (DE)

(21) Appl. No.: 18/998,100

(22) PCT Filed: Jun. 16, 2023
(86) PCT No.: PCT/EP2023/066310

§ 371 Date: Jan. 23, 2025

(30) Foreign Application Priority Data
Jul. 29, 2022 (DE) 10 2022 119 149.4

(51) Int. Cl. G06V 20/56; G06V 10/14

(52) U.S. Cl. CPC G06V 20/56; G06V 10/14; G06V 2201/08

(57) ABSTRACT

A method for analyzing an external vehicle status of a vehicle includes positioning the vehicle in front of a reflective surface to create a reflection of the vehicle in the reflective surface within a detection region of a camera, or detecting that the vehicle is positioned in front of the reflected surface such that the reflection of the vehicle is within the detection region of the camera. The method also includes recording an image of the reflection of the vehicle using at least in part the camera, to create an image recording. The method further includes analyzing the image recording with regard to a vehicle status, and outputting information containing the vehicle status.

The present application is the U.S. national phase of PCT Application PCT/EP2023/066310 filed on Jun. 16, 2023, which claims priority of German patent application no. 10 2022 119 149.4 filed on Jul. 29, 2022, the entire contents of which are incorporated herein by reference.

### TECHNICAL FIELD

The present disclosure relates to vehicles, and more particularly, to analysis of vehicle status. E

### BACKGROUND

Motor vehicles are usually designed in such a way that they have an attractive appearance. Users of motor vehicles have a desire to use a clean and undamaged vehicle with a flawless appearance. When renting or leasing motor vehicles or offering transport services (for example taxi services), it is therefore necessary to ensure that the vehicles are always well maintained, for example clean and with no dents.

When a rented or leased vehicle is returned, it usually undergoes an inspection, which also determines whether the vehicle is excessively dirty or has dents. However, it can be difficult to quantify the degree of fouling or possible damage to the leased vehicle in a sufficiently quantified manner, which can lead to disputes between the renter and the lessor of the vehicle. Furthermore, it can lead to considerable personnel effort, especially in the case of large fleets, to regularly inspect each individual vehicle for dirt or damage.

In vehicle fleets, the automatic detection of dirt on and damage to the vehicle is therefore a relevant problem. This applies in particular to fleets of autonomous vehicles, as no human driver can carry out a visual inspection for fouling or damage during operation.

In WO 2021 055 988 A1, a system and a method for the self-inspection of a vehicle are disclosed. The self-inspection can be carried out by an application that runs on a mobile device, wherein the application is configured to determine excessive wear and tear and usage. The mobile device can receive images of multiple predetermined views of the vehicle, wherein a damage input is determined for the multiple predetermined views. In return, an estimate of the cost of repair or replacement based on the damage may be provided for each of the several pre-existing agreed views as well as total costs for repair or replacement can be output, which can be dynamically updated.

U.S. Pat. No. 2,019,266 715 A1 discloses methods, systems and computer program products for the use of unmanned aerial vehicles (UAVs) for the inspection of autonomous vehicles. An autonomous vehicle carries a UAV (or “drone”) in a protected area, for example in a glove box, trunk, etc. Between trips, the UAV can be used to inspect the autonomous vehicle. Images from the UAV can be sent to other components for image analysis. When an inspection is completed, the UAV can return to the protected area. The UAV can inspect both the interior and exterior of an autonomous vehicle. If an inspection is passed, the autonomous vehicle can start a new journey. If an inspection is not passed, the autonomous vehicle can report for repair or call a tow truck.

A disadvantage of well-known concepts can be that additional devices such as mobile devices (for example smartphones) or additional drones that have to be placed in the vehicle are needed to determine the condition of a vehicle. This can be inconvenient and lead to excessively high costs of vehicle inspection.

### SUMMARY

It is an object of the present disclosure to provide improved concepts for carrying out inspections concerning the external status of vehicles.

This object is achieved according to the subject matter of the independent patent claims. Other advantageous embodiments are described in the dependent patent claims, the following description and in connection with the figures.

Exemplary embodiments concern methods for analyzing the external status of a vehicle. Cameras in particular can be used for optical analysis, so that dirt on or damage to the vehicle can be detected in recorded images of the vehicle. In addition, a corresponding computer program is proposed for carrying out the method.

Accordingly, a method for analyzing an external status of a vehicle is proposed. In particular, an optical or visual analysis or inspection of the external status of the vehicle is carried out. The method involves positioning the vehicle in front of a reflective surface so that the vehicle reflected in the reflective surface is within the detection region of a camera. Alternatively, recognition is provided according to the method if the vehicle is positioned in such a way in front of a reflective surface (for example if there is already a suitable reflective surface in the vicinity of the vehicle so that the vehicle no longer needs to be moved there; for example if a driver of the vehicle has already manually positioned the vehicle in front of the reflective surface or drives past the reflective surface). For example, the vehicle can stop in front of the reflective surface or, alternatively, drive past the reflective surface so that it is reflected in the surface. The detection that the vehicle is in front of a reflective surface can be carried out by means of vehicle software and sensors, whereupon the further steps of the method can be initiated. The other envisaged steps are recording an image of the reflected vehicle using the camera, analyzing the recorded image with regard to the status of the vehicle and outputting information containing the vehicle status.

It is advantageous to carry out the method automatically. As a result, the vehicle itself can detect whether the vehicle exterior is in good condition (for example clean) or has dirt or damage, for example, such as dents or scratches, as soon as it is in front of a reflective surface. By outputting the information, a suitable measure can subsequently be taken, for example to restore the vehicle exterior to a proper condition. By avoiding the need for manual steps, efficient self-inspection of the vehicle can be carried out. It is advantageous to dispense with external cameras, for example those of cell phones or drones.

As already mentioned, according to one aspect, the status of the vehicle relates to fouling of or damage to the vehicle exterior. Using the camera in conjunction with the reflective surface can be particularly easy, as the suggested method focuses on the inspection of the exterior of the vehicle and no further, complicated measures are necessary to inspect the interior of the vehicle. The analysis of whether there is dirt or dents on the vehicle is particularly relevant, as this can occur frequently. Since this type of inspection has to be carried out frequently, an efficient method such as the one proposed here may be particularly advantageous for this purpose.

According to one aspect, it is proposed that multiple images of the reflected vehicle are recorded from different angles or a video sequence of the reflected vehicle is recorded. For example, the vehicle can be maneuvered in front of the reflective surface in order to analyze several side surfaces of the vehicle. For example, while the video sequence is being recorded, the vehicle is moved in front of the reflective surface, for example the vehicle maneuvers autonomously front of the in reflective surface. In particular, an angle of the vehicle in relation to the reflective surface can be changed, for example in order to be able to better detect dents from the resulting reflections. Alternatively, it can be provided that a swiveling camera (for example of the vehicle itself) is used and the camera pans, for example when reflective surfaces are available on several sides of the vehicle. In this way, a larger area of the of the outer surface of the vehicle can be inspected.

According to one aspect, it is provided that a vehicle camera of the vehicle itself is used to record the image. Since many vehicles are already equipped with cameras (for example a reversing camera or a front camera for assisted driving functions), the method can be used particularly efficiently for these vehicles. Alternatively, for example, a smartphone camera can also be used, which is for example linked to the vehicle to record an image of the reflected vehicle. For example, an in-vehicle camera of another (for example autonomously driving) vehicle can also be used to record the image.

For example, the method may also include adjusting a route guidance of the vehicle in order to navigate the vehicle to a suitable reflective surface. In particular, the route can be adjusted in advance of the steps described above. A route guidance along a glass façade or similar can be particularly advantageous, since in this way an image can be recorded while driving. For example, several reflective surfaces can be driven past one after the other, wherein the reflective surfaces are on different sides of the vehicle. This can be used, for example, to inspect the entire outer surface of the vehicle.

As already mentioned, according to one aspect, the vehicle can be an autonomously driving vehicle. Autonomously driving vehicles can offer passenger transport, for example. The method allows the autonomously driving vehicle to automatically check whether the external appearance thereof is adequate or not before each trip, for example. For example, a tolerance limit for fouling may depend on the passenger, just as certain debris on the exterior of the vehicle may be acceptable for certain passengers but not for others. In this way, a fleet operation can run more smoothly, for example for less demanding users in terms of appearance. For example, a user of the transport service can indicate in their profile whether they would prefer to use a dirty vehicle if necessary or wait for a cleaned vehicle.

For example, the method may also involve navigating the vehicle to a workshop or car wash depending on the status of the vehicle. Navigating to the workshop or car wash can be carried out in particular following the steps described above. For example, navigation information can be output to a vehicle driver or the vehicle can be driven autonomously to the workshop or car wash. In particular, it is intended that the vehicle will only be navigated to the workshop or car wash if the status of the vehicle is worse than a predetermined (for example maximum) tolerance value for fouling or damage. The tolerance value can describe, for example, a maximum acceptable fouling or damage. Navigation to the workshop or car wash can be carried out, for example, only if there is too much fouling on too large a surface or too large a dent or a scratch have been detected, which require repair in the workshop or cleaning of the vehicle. Thus, it can be advantageously quantitatively decided whether the vehicle can be used again immediately or whether the external appearance must first be restored.

According to one aspect, the method is used to assess the external vehicle statuses of a plurality of vehicles in a vehicle fleet, in particular an autonomous vehicle fleet. Especially in the case of a plurality of autonomously driving vehicles, it can be advantageous if they can inspect themselves, as no drivers can carry out this inspection and a non-automatic inspection would generate a high level of personnel cost.

Another aspect concerns a method for analyzing an external status of a first vehicle. The method includes the steps of positioning the first vehicle in front of another, autonomously driving vehicle with a vehicle camera, so that the first vehicle is within the detection region of the vehicle camera of the other vehicle. The positioning can be carried out from the perspective of both vehicles, for example the first vehicle can be moved towards the other vehicle and/or the other vehicle can be moved towards the first vehicle. Alternatively, it can be detected that the vehicle is positioned in such a position in front of the other vehicle (for example if another vehicle with a camera is already in the vicinity of the first vehicle, so that the first vehicle no longer has to be moved there; for example if a driver of the first vehicle has already manually positioned the first vehicle in the vicinity of the other vehicle or drives past the other vehicle; for example if the other vehicle drives past the first vehicle, for example autonomously). The detection that the first vehicle is in front of the other vehicle can be carried out by means of vehicle software and sensors, whereupon carrying out of the further steps of the method can be initiated. The further steps envisaged are recording an image of the first vehicle using the camera of the first vehicle, analyzing the recorded image with regard to the vehicle status of the first vehicle and outputting information containing the status of the first vehicle. The other vehicle can be of the same type of vehicle as the first vehicle, for example both vehicles can be passenger cars.

An advantage of this method over the prior art can be that an inspection can be carried out using an external camera without having to carry a drone or the like in the vehicle for this purpose. On the other hand, according to the proposed method, a camera of another road vehicle may be used, for example if it drives past the first vehicle by chance or by plan or is in the vicinity thereof. In particular, the method can be advantageous if at least some vehicles in a vehicle fleet are already equipped with cameras, as these cameras can be used efficiently to carry out the method.

Another aspect concerns a computer program with program code for carrying out the method described above or below when the computer program is run on a processor, a computer, or programmable hardware. Such a computer program can advantageously be installed on an on-board computer of a vehicle (for example of an autonomously driving vehicle) or made available on a server (for example cloud-based implementation of the method).

### BRIEF DESCRIPTION OF THE DRAWINGS

FIG. 1 shows a flowchart of a method for analyzing the external status of a vehicle;

FIG. 2 shows a schematic example of a vehicle positioned in front of a reflective surface in order to record a reflected image of the vehicle by means of a vehicle camera; and

FIG. 3 shows a schematic example of a vehicle that is maneuvered within a detection region of a camera of another vehicle.

### DESCRIPTION

Various exemplary embodiments are now described in more detail with reference to the accompanying drawings, in which some exemplary embodiments are shown. In the figures, the thickness dimensions of lines, layers and/or regions may be exaggerated for the sake of clarity. In the following description of the following figures, which show only a few exemplary embodiments, identical reference signs designate the same or comparable components.

An element that is said to be “connected” or “coupled” to another element may be directly connected or coupled to the other element, or there may be elements in between. Unless otherwise defined, all terms used herein (including technical and scientific terms) shall have the same meaning as those given to them by an average person skilled in the art in the field to which the examples of the design belong.

Dirt on and damage to the vehicle are currently manually detected by the vehicle user. Or the individual degree of fouling/damage is determined by personnel, for example in vehicle fleets. These processes are resource-intensive and require personnel. There are known inventions that determine the degree of fouling/damage on the basis of field data (for example mileage, ambient conditions). However, these methods are not as precise as visual monitoring using image information.

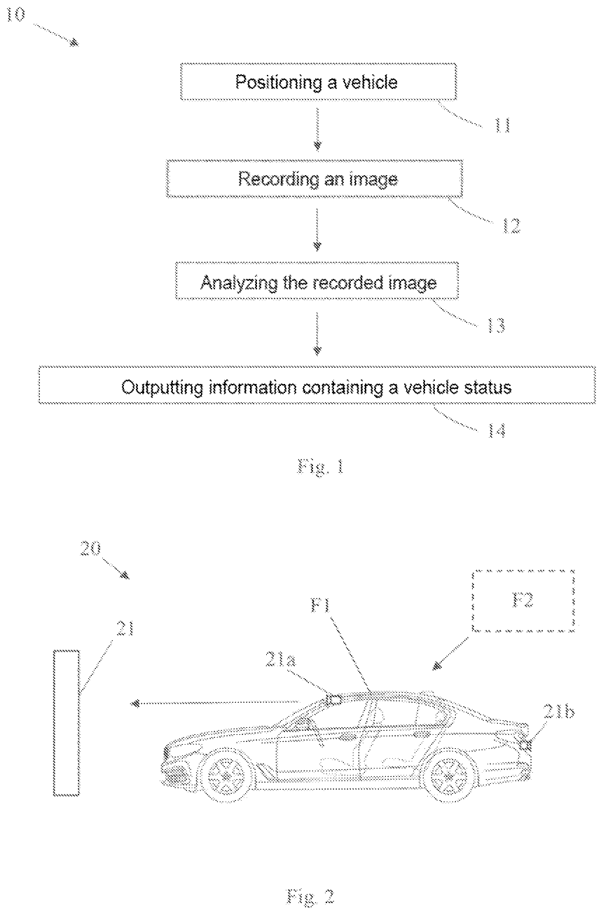

FIG. 1 shows a flowchart of a method 10 for analyzing an external status of a vehicle. The method 10 includes the steps of positioning 11 a vehicle, recording 12 an image, analyzing 13 the recorded image and outputting 14 information containing a vehicle status of the vehicle.

According to a first embodiment of the method 10, the vehicle is positioned 11 in front of a reflective surface so that the vehicle reflected in the reflective surface is within the detection region of a camera. Alternatively, detection that the vehicle is positioned in such a way in front of the reflective surface can be carried out (for example by means of the vehicle system). In this case, recording 12 the image of the reflected vehicle can be carried out by means of the camera. Analyzing 13 the recorded image can be carried out with regard to the vehicle status of the vehicle.

The advantage of this embodiment can be that a self-inspection of the vehicle can be carried out without the need for further external electronic devices. For example, for analyzing the exterior of the vehicle, a smartphone or drone that can record images can be dispensed with. Image recording can be carried out by advantageous use of existing reflective surfaces in the vicinity and, for example, an already existing vehicle camera of the vehicle itself. As a result, a self-inspection of the vehicle can be carried out very efficiently.

According to a second embodiment of the method 10, the vehicle, in particular a first vehicle, is positioned 11 in front of another autonomously driving vehicle with a vehicle camera, so that the first vehicle is within the detection region of the camera of the other vehicle. Alternatively, detection that the first vehicle is positioned in such a way in front of the other vehicle can be carried out. Recording 12 the image of the first vehicle is carried out by means of the camera of the other vehicle, whereupon the analysis 13 of the recorded image is then carried out with regard to the status of the first vehicle. Finally, the information containing the status of the first vehicle will be output 14.

The advantage of the second embodiment may be that no reflective surfaces are needed to carry out an analysis of the external appearance of the first vehicle. Rather, an existing camera of another vehicle can be used in an efficient way, which can be particularly useful when analyzing fleets of vehicles with several vehicles, as the vehicles can inspect each other. In the second proposed embodiment, too, a smartphone or drone capable of recording images for analyzing the exterior of the vehicle can be dispensed with.

The proposed methods solve the problem of the costly inspection of vehicles by the vehicle itself or the interaction between different vehicles. A vehicle recognizes for example by its s built-in optical sensors (for example cameras) that it is driving past a reflective object, for example. This can be implemented, for example, using a suitable AI (artificial intelligence) model. Subsequently, images of the reflective surfaces are recorded and evaluated, for example, with another AI model that detects fouling and damage. This allows the vehicle to detect dirt on and damage to itself without the need for an external device with a camera. The method can also be extended by interaction with other autonomous vehicles. Here, the camera systems of other vehicles can be used to investigate images of the outer areas of a vehicle in order to visually resolve all areas of the vehicle. The same AI models as mentioned above can be used here.

An illustrative example can describe the proposed method in more detail: a vehicle (for example autonomous) is equipped with software for the detection of fouling and damage. It recognizes by means of the sensor system that is installed for autonomous driving functions (especially cameras) that it will soon pass a reflective surface (for example the glass front of a building). While driving past the reflective surface, the vehicle uses the sensors to record images of the glass front, and thus of itself (reflected in the glass front). These images are evaluated for damage and fouling by an installed (or cloud-hosted) AI model. If damage or fouling is detected, this information is sent to a control center, for example (such as for fleet management of a vehicle fleet). Now, for example, suitable measures can be taken for repair or cleaning of the vehicle.

FIG. 2 shows a schematic example 20 of a vehicle F1 positioned in front of a reflective surface 21 in order to record a reflected image of the vehicle F1 by means of a vehicle camera 21a. The reflective surface can be for example a glass façade or the reflective surface of another vehicle or object (for example a traffic mirror).

The vehicle F1 can have a front camera 21a and a rear camera 21b. Depending on the position of the reflective surface 21, it may be advantageous to use the front camera 21a or rear camera 21b to record an image of the reflected vehicle F1. In the example of FIG. 2, the front of the vehicle F1 is facing the reflective surface 21, so that the front camera 21a can take a picture of the reflection of the vehicle F1 in the reflective surface 21. In this way, an image can be provided which can enable an analysis of the front of the vehicle F1 with regard to the external status of the vehicle. For example, dirt or dents on the front of the vehicle F1 can be detected in the image.

If necessary, the vehicle F1 can maneuver in front of the reflective surface 21, for example can turn, so that the rear camera 21b can record the vehicle F1 reflected in the reflective surface 21. In this way, the rear of the vehicle F1 can also be analyzed with regard to the external status of the vehicle.

The vehicle F1 can be driven in front of the reflective surface 21, for example, in order to enable the image recording. Here, for example, the vehicle F1 can stop in front of the reflective surface 21. Alternatively, a vehicle sensor system can also detect when driving past the reflective surface 21 that an image of the vehicle suitable for analysis can be recorded as it passes by, so that the vehicle F1 does not have to stop for this purpose, but continue its can journey without interruption. A vehicle control system can be designed accordingly for the detection of reflective objects (for example by means of vehicle sensors; such as by means of the vehicle cameras 21a, 21b) and for the evaluation of the reflected vehicle surface (for example on the basis of the recorded image).

For example, one or more of the following steps can be carried out: recording from the vehicle (for example a camera on the side, for example in the side mirror of the vehicle F1); if the vehicle is detected (for example in the reflective surface 21; for example by means of object detection, for example AI-based), then checking whether the detected vehicle in the image is stationary relative to the vehicle F1 (for example to check whether the vehicle actually recognizes itself); classification of the reflected vehicle (for example by comparison with vehicle features) to be sure that it is the subject vehicle (for example to avoid other vehicles being analyzed); producing an image section and segmentation (for example of the recorded image); and/or object recognition classification to detect fouling or damage.

In addition, another vehicle F2 (depicted schematically) can record an image of the vehicle F1 with a camera of the other vehicle F2. As a result, a recorded image suitable for the analysis of the exterior of the vehicle F1 can also be provided. The recorded image can be transmitted directly from the other vehicle F2 to the vehicle F1 or transmitted via a cloud (not shown). The analysis of the recorded image can be carried out, for example, in the recording vehicle F1, in the other vehicle F2 or in the cloud.

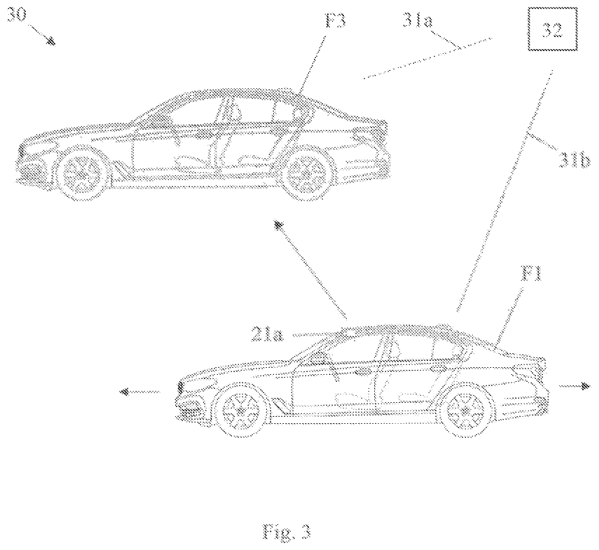

Further details and aspects are set out in conjunction with the exemplary embodiments described above or below. The exemplary embodiment shown in FIG. 2 may have one or more optional additional features corresponding to one or more aspects mentioned in connection with the proposed concept or with one or more exemplary embodiments described above (for example FIG. 1) or below (for example FIG. 3).

FIG. 3 shows a schematic example 30 of a first vehicle F3, which is maneuvered into the detection region of a camera 21a of another vehicle F1. According to the relative relationship between the two vehicles F3, F1, the first vehicle F3 and/or the other vehicle F1 can be moved for this purpose. For example, the other vehicle F1 can be an autonomously driving vehicle that can position itself in front of the first vehicle F3 in such a way (represented schematically by arrows for driving forward and backward) that the first vehicle F3 is positioned in a detection region of the vehicle camera 21a. An image of the first vehicle F1 can be recorded.

Thus, an image of the first vehicle F3 can be recorded, for example by another, autonomously moving vehicle F1. The image acquisition can be automatic, for example, if the other vehicle F1 recognizes a vehicle structure. The recorded image can be sent to a backend 32 or a cloud 32, wherein the vehicles can be connected to the cloud 32 via respective communication links 31a, 31b.

Based on the recorded image, an evaluation of the vehicle surface of the first vehicle F3 can be carried out (for example in the other vehicle F1 or in the cloud 32) and information regarding the evaluation can be sent to the first vehicle F3 (or the cloud 32).

Further details and aspects are given in connection with the exemplary embodiments described above or below. The exemplary embodiment shown in FIG. 3 may have one or more optional additional features that correspond to one or more aspects mentioned in connection with the proposed concept or with one or more exemplary embodiments described above (for example FIGS. 1-2) or below.

Examples relate to autonomous fouling detection by means of indirect methods and the use of artificial intelligence. It is envisaged that a vehicle control system or a vehicle system detects reflective objects, records an image of the vehicle reflected therein and carries out an evaluation of the vehicle surface reflected in the reflective object. If damage or fouling of the surface of the vehicle is detected, this information can be transmitted and, for example, repair or cleaning measures can be taken.

1.-11. (canceled)

12. A method for analyzing an external vehicle status of a vehicle, the method comprising:
positioning the vehicle in front of a reflective surface to create a reflection of the vehicle in the reflective surface within a detection region of a camera or detecting that the vehicle is positioned in front of the reflected surface such that the reflection of the vehicle is within the detection region of the camera;
recording an image of the reflection of the vehicle using at least in part the camera, to create an image recording;
analyzing the image recording with regard to a vehicle status; and
outputting information containing the vehicle status.

13. The method as claimed in claim 12,
wherein the vehicle status concerns fouling on or damage to an outside of the vehicle.

14. The method as claimed in claim 13,
wherein multiple images of the reflection of the vehicle are recorded from different angles and are used to create the image recording.

15. The method as claimed in claim 12,
wherein multiple images of the reflection of the vehicle are recorded from different angles and are used to create the image recording.

16. The method as claimed in claim 12,
wherein a video sequence of the reflected vehicle is recorded and is used to create the image recording.

17. The method as claimed in claim 16,
wherein the vehicle status concerns fouling on or damage to an outside of the vehicle.

18. The method as claimed in claim 12, wherein the camera is a vehicle camera of the vehicle.

19. The method as claimed in claim 12, wherein:
positioning the vehicle in front of a reflective surface further comprises adapting a route guidance of the vehicle to navigate the vehicle to the front of the reflective surface.

20. The method as claimed in claim 19,
wherein the vehicle is an autonomously driving vehicle.

21. The method as claimed in claim 12,
wherein the vehicle is an autonomously driving vehicle.

22. The method as claimed in claim 12, further comprising:
navigating the vehicle to a workshop or car wash depending on the vehicle status.

23. The method as claimed in claim 22,
wherein the vehicle is navigated to the workshop or car wash if the vehicle status is determined to be worse than a predetermined minimum tolerance value for fouling or damage.

24. The method as claimed in claim 12,
wherein the method is used to assess an external vehicle status of a plurality of vehicles of a vehicle fleet.

25. A non-transitory computer-readable medium containing program code for carrying out the method as claimed in claim 12, when the program code is executed on a processor, computer, or programmable hardware.

26. A method for analyzing an external status of a first vehicle, the method including:
positioning the first vehicle in front of a second vehicle, the second vehicle being an autonomously driving vehicle having a vehicle camera so that the first vehicle is within a detection region of the vehicle camera of the second vehicle, or detecting using the vehicle camera that the first vehicle is positioned in front of the second vehicle;
recording an image of the first vehicle at least in part using the vehicle camera of the second vehicle, to generate an image recording;
analyzing the image recording with regard to a vehicle status of the first vehicle; and
outputting information containing the vehicle status of the first vehicle.

27. The method as claimed in claim 26,
wherein the vehicle status concerns fouling on or damage to an outside of the vehicle.

28. A non-transitory computer-readable medium containing program code for carrying out the method as claimed in claim 12, when the program code is executed on a processor, computer, or programmable hardware
